(19) United States
(12) Patent Application Publication
(10) Pub. No.: US 2017/0136965 A1
(43) Pub. Date: May 18, 2017

(54) Bridging component and edge trim strip as well as system made from them

(71) Applicant: DURA Automotive Holdings U.K., Ltd., Birmingham (GB)

(72) Inventors: Frank SCHULTE, Balve (DE); Dennis IFFLAND, Plettenberg (DE); Kai WINKHAUS, Herscheid (DE); Margit STEIN-HÖRICH, Lennestadt (DE)

(21) Appl. No.: 15/352,931

(22) Filed: Nov. 16, 2016

(30) Foreign Application Priority Data
Nov. 16, 2015 (DE) 10 2015 119 783.9

(51) Int. Cl. B60R 13/02

(52) U.S. Cl. CPC B60R 13/02; B60J 5/0493

(57) ABSTRACT

In a system made from an edge trim strip and a bridging component for the bridging, especially in optical manner, of a structural transition between the edge trim strip and the bridging component, a simple and secure connection of the edge trim strip and the bridging component should be made possible with the simplest possible fabrication and design of the edge trim strip. The securing of the bridging component to the edge trim strip is accomplished solely by a fastening leg provided on the edge strip and forming an undercut, and the fastening leg is the sole leg of the cross section profile of the edge trim strip serving to secure the bridging component. The bridging component has a locking means in the form of a locking groove, which is able to engage at top and bottom with the fastening leg provided with the undercut in a locking manner.

### INTRODUCTION

The invention concerns a bridging component which is designed for bridging, especially in optical manner, of a structural transition from an edge trim strip closing off the window shaft of a vehicle door of an automobile and an adjoining neighbouring part. The invention moreover concerns such an edge trim strip as well as a system made from an edge trim strip and a bridging component.

In automobiles, especially passenger cars, the upper edges of the window shafts into which the window panes descend when they are let down are provided with edge trim strips, which optically close off from the outside the respective window shaft as decorative strips. In this way, the edge trim strips create an optically pleasing termination of the window shaft and distinguish in a not insignificant manner the external appearance of the vehicle thanks to their generally different colour and/or surface configuration from the vehicle body, e.g. as chrome, aluminum or stainless steel strips (being painted, polished, matt brushed, etc.). Edge trim strips usually interact with piping or seals along the length of the window shaft, in order to be held against the body of the vehicle. Together with the piping or seals serving as the actual fastening to the vehicle, they form shaft covering or closing strips. Edge trim strips are also called edge trim bars.

Besides such an edge trim strip in many cases vehicle doors also have (window) frame strips which not uncommonly correspond in their material and/or surface finish to the edge trim strip and thus form together with the edge strip a frame encircling the window pane. Likewise, edge trim strip and frame strip abut against each other at transitions from one structural part to another.

In the region of the structural transition between frame strip and edge trim strip (in the region in which the end section of the frame strip abuts against an end section of the edge strip), the edge trim strip is trimmed or milled to give it a contour adapted to the end section of the frame strip. This is supposed to ensure that the frame strip and the edge trim strip pass as smoothly and optically unnoticeably as possible into each other, especially without forming a conspicuous gap. Despite such trimming or milling, ultimately the formation of a shadow joint at the gap is unavoidable. In order to stabilize the gap appearance and also secure and orient in a defined manner both parts in relation to each other, one can make use of a bridging component.

Edge trim strips with installable end caps are known from the prior art. An end cap with such a design can also be configured as a bridging component or a bridging component with such a design configuration can also take on the function of an end cap. Such end caps, when interlocked per design with the edge trim strip, form an end surface optically terminating the edge trim strip. End caps are inserted primarily in the axial direction, i.e., parallel to the (lengthwise) direction of extension of an edge trim strip, into the open end cross section of the edge trim strip and interlock with the edge trim strip upon reaching their designated end installation position. The open-ended profile cross section of the edge trim strip typically forms undercuts which interact with corresponding locking means provided on the end cap, so that the end cap in the end installation position is also secured transversely to the axial direction of extension on the edge strip. The axial insertion of an end cap in the edge trim strip is, however, problematic or even impossible when the end surface of the edge trim strip is supposed to be accomplished by turning over a material region of the decorative strip ends, so that there is no open-ended profile cross section into which an end cap could be inserted in the axial direction. In such cases, an end cap must be interlocked with the edge trim strip by a movement oriented transversely to its lengthwise direction of extension. Also in this case the edge trim strip has undercuts which interact with locking means of the end cap or bridging component.

If the edge trim strip is trimmed or milled in the region relevant to an end cap or a bridging component for purposes of adaptation to the adjoining contour of the frame strip, sections of the profile cross section of the edge trim strip, especially the profiled leg, are eliminated by the trimming or the milling, such as are required or at least would be suitable for the fixation of an end cap or a bridging component. Therefore, profile cross sections of the typically extruded edge trim strip are provided with a middle web, which serves exclusively for the interlocking with the bridging component in the end section and is positioned such that it is not eliminated during the trimming of the end section of the edge trim strip, yet still ensures the connection or interlocking of bridging component and edge trim strip. The providing of such a middle web, however, means in turn that this must be removed, especially in the region of the end face of the edge trim strip (the outer end of the edge trim strip), in which a material region is supposed to be turned over in order to form an axial end surface, prior to the turning over of the material region. This not only causes additional expense, but can also entail an undesirable and detrimental influencing of the surface of the structural parts.

What is more, when such a middle web is present, there is a danger that this can be noticeable on the outer decorative surface of the edge trim strip.

In addition to a (window) frame strip, the above described situation can also occur with other decorative or frame strips (such as pillar panels). Whenever frame strips are mentioned in the course of this application, the term is not confined to window frame strips, but also applies generally to decorative strips, pillar panels, or other (moulding) structural parts requiring a structural transition between two adjacent parts as structural parts adjacent to an edge trim strip.

The problem which the invention proposes to solve is therefore to provide a system composed of an edge trim strip and a bridging component which enables a simple and secure connection of the two structural parts with the simplest possible fabrication and design of the edge trim strip.

### SUMMARY

Regarding an edge trim strip for mounting on the edge of a vehicle door of a passenger car, which is trimmed in an end section, where a structural transition to an adjoining frame strip is realized when the edge trim strip is installed per design on the motor vehicle, in order to approximate the contour of the adjacent frame strip, and which comprises in the end section a cross section profile with a base leg, which forms an outer decorative surface with a lower visible edge bordering on the decorative surface when the edge trim strip is mounted per design on the vehicle, and in which an inwardly facing fastening leg is provided, emerging from the base leg, when the edge trim strip is arranged per design on the motor vehicle, for the fixation of a bridging component on the edge trim strip, it is specified as the solution of the problem that the fastening leg in the region of the trimmed end section of the edge trim strip is the sole leg of the cross section profile serving to secure the bridging component. Accordingly, besides the fastening leg, the edge trim strip has no additional leg or web with which the bridging component interacts for purposes of locking to the edge trim strip.

The bridging piece for the bridging, especially in optical manner, of an edge trim strip when mounted per design on a motor vehicle and a structural transition forming a window frame strip has a cross section with a locking means which is designed to engage with an undercut located on a fastening leg of the edge trim strip when arranged per design on the edge trim strip. As the solution of the problem, it is provided that the locking means is formed by a locking groove, which engages at top and bottom with the fastening leg provided with the undercut in a locking manner.

Edge trim strip and bridging component interact here in a system where the fixation of the bridging component to the edge trim strip occurs only at the one fastening leg.

Accordingly, the bridging component is held against the edge trim strip solely via the locking connection formed by the locking groove and the fastening leg. Thus, no additional middle web is required extending inward from the base leg, i.e., a middle web starting from the inner surface of the base leg facing the vehicle when the edge trim strip is mounted on the vehicle as designed and extending in the direction of the vehicle body.

The fastening leg preferably extends inwardly at an angle α less than 90°, preferably at an angle α less than 45°, to the base leg, starting from the lower visible edge of the base leg. The fastening leg and the base leg accordingly meet preferably in the region of a lower edge of the cross section profile of the edge trim strip, forming the lower visible edge of the edge trim strip, and make an acute angle between them.

In the region of its end facing away from the base leg the fastening leg forms an undercut, in order to produce a locking element acting transversely to the lengthwise direction of extension of the edge trim strip and able to be grasped by the bridging component. The undercut is here preferably formed by a thickening, a bend, or a locking lug.

For the purposes of a locking engagement with the undercut, it can be advantageously provided that the locking groove of the bridging component has a widening, preferably in the region of the bottom of the groove, in order to accommodate the locking element located on the fastening leg, the shape of the widening being adapted to the shape of the locking element.

In order to hold the bridging component reliably against the edge trim strip, and in particular to be able to effectively interlock with it, the locking groove has an upper groove leg and a lower groove leg. Preferably at least one of the two groove legs (preferably the upper groove leg) has, at its end facing away from the bottom of the groove, a constriction engaging with the undercut of the fastening leg, in the region of which the groove width of the locking groove is reduced, and which broadens out initially when mounted on the fastening leg. Also preferably one of the two groove legs (preferably the lower groove leg) forms an abutment for the other groove leg (preferably the upper groove leg) engaging with the undercut of the fastening leg.

One groove leg (preferably the lower groove leg forming the abutment) extends beyond the other groove leg (preferably the upper groove leg forming the constriction) looking in a direction of principal action of the interlocking between edge trim strip and bridging component.

Viewed along its overall length, the edge trim strip has a middle section and a trimmed end section at one end or at both ends. The edge trim strip preferably has in the non-trimmed middle section a C-shaped cross section profile, having besides or in addition to the fastening leg preferably arranged at the bottom an upper profiled leg arranged preferably at the top and bent inwardly at an (acute) angle from an upper visible edge. In the region of the end section relevant to the bridging component, the upper profiled leg has been eliminated as a result of its trimming.

The edge trim strip and the bridging component are preferably adapted to each other such that the direction of principal action of the interlocking between bridging component and edge trim strip is oriented in the yz direction in relation to the vehicle and when the edge trim strip is mounted as designed on the vehicle. The yz direction means a direction having directional components both in the y direction and the z direction, while the two directional components need not have the same magnitude.

In particular if it is provided that a material region of the edge trim strip is turned over at the end face of the edge trim strip in order to create an end surface, it is advantageous for the bridging component to be designed so that it can be set on the edge trim strip transversely to its lengthwise extension, thus, in particular, in the yz direction in relation to the vehicle when the edge trim strip is arranged as designed on the vehicle (in the direction of principal action of the interlocking).

In a system made up of an edge trim strip and a bridging component according to the invention, it is not necessary to provide a middle web for the fastening of the bridging component to the edge trim strip. Instead, the bridging component can be held solely via the locking connection formed by the locking groove and the fastening leg on the edge trim strip. Hence, there is no problem in eliminating any profiled leg still present in a middle section of the preferably extruded profile cross section of the edge trim strip as a result of a trimming of the edge trim strip in an end section and it does not require the providing of a middle web.

### BRIEF DESCRIPTION OF THE DRAWINGS

The following drawings and the following description of preferred exemplary embodiments illustrate the features and advantages of the invention. In the drawings:

FIG. 1a is a cross section through an edge trim strip with a bridging component set thereon according to the prior art,

FIG. 1b is a back side of an end section of the edge trim strip of FIG. 1 without any bridging component mounted on it,

FIG. 2 is a cross section of an edge trim strip with a bridging component mounted on it at the back side,

FIG. 3a is a first view of an end section of the edge trim strip of FIG. 2 with bridging component mounted on it or shown detached from the edge trim strip,

FIG. 3b is a second view of an end section of the edge trim strip of FIG. 2 with bridging component mounted on it or shown detached from the edge trim strip, and

FIG. 3c is a third view of an end section of the edge trim strip of FIG. 2 with bridging component mounted on it or shown detached from the edge trim strip.

### DETAILED DESCRIPTION

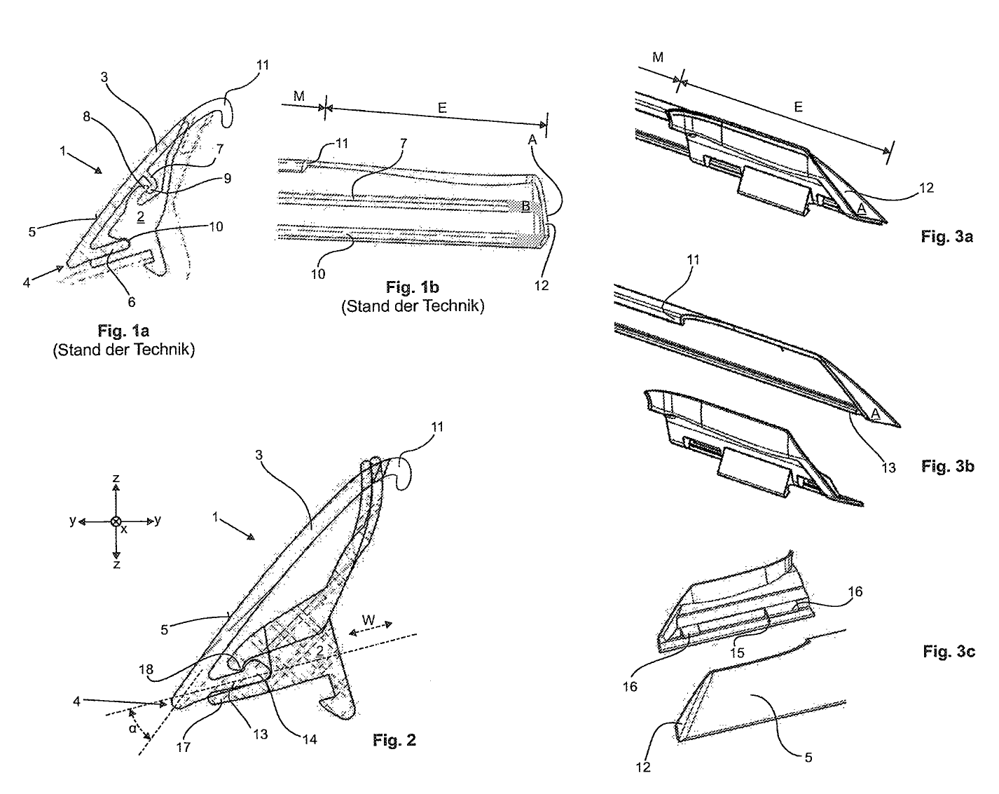

FIG. 1a shows an edge trim strip 1 with a bridging component 2 mounted on it at the back side, as is known in the prior art. FIG. 1b shows an end section of the edge trim strip 1 in a rear view without the bridging component.

The edge trim strip 1 has a base leg 3, which forms by its outwardly facing surface when mounted as intended on the motor vehicle an outwardly visible decorative surface 5. The decorative surface is bounded at the bottom side by a lower visible edge 4. Starting from this lower edge, an auxiliary leg 6 extends inwardly.

The bridging component 2 on the one hand engages by a locking protrusion 8 with the locking lug 9 of a middle web 7 extending inwardly from the back side of the base leg 2 and on the other hand is braced by a bearing 10 against the auxiliary leg 6. Thus, for the interlocking of the bridging component 2 on the edge trim strip 1, the bearing 10 and locking protrusion 8 interact with the auxiliary leg 6 and middle web 7.

It is evident from FIG. 1b that in the region of the trimmed end section E an upper profiled leg 11 still existing in the middle section M of the edge trim strip has been removed due to the trimming of the edge trim strip evident from FIG. 1b. The trimmed and thus in the end section eliminated upper profiled leg 11 is indicated by broken line in FIG. 1a. The middle web 7 initially becomes necessary on account of the elimination of this upper profiled leg 11, which would basically be suitable for a grasping and locking of the bridging component on the edge trim strip, since without the middle web 7 it would not be possible to produce any two-sided locking acting on the bridging component 2 and securing it adequately against the edge trim strip 1.

FIG. 1b further illustrates that, when it is necessary to form an end surface A produced by overturning a material region 12 at the end of the edge trim strip, the middle web 7 and the auxiliary leg 6 have to be removed in a machining region B, or else they would stand in the way of an overturning of the material region 12.

The embodiment of FIG. 2 and FIGS. 3a-3c makes it clear that there is no middle web for the edge trim strip 1 shown there in cross section. Here as well, the upper profiled leg 11 still present in a middle section M of the edge trim strip 1 has been eliminated in the end section E, being indicated visually by a broken line in FIG. 2.

Instead of the middle web, the cross section profile of the edge trim strip 1 shown in FIG. 2 has a fastening leg 13, which forms a thickening 14 at its end facing away from the base leg 3, which is grasped at the top and bottom by a locking groove 15 formed on the bridging component 2 in a locking manner. The thickening—which could also be a bend or a locking element formed in a different manner, forming an undercut—forms an undercut acting in a direction W of principal action of the interlocking (yz direction in relation to the motor vehicle and transversely to the lengthwise direction of extension of the edge trim strip) and thus constitutes a locking element able to be grasped by the bridging component.

The fastening leg 13 starting from the lower visible edge 4 extends inwardly and makes with the base leg an acute angle α. The locking groove 15 grasping the fastening leg 13 has an upper groove leg 16 and a lower groove leg 17, while the lower groove leg extends significantly beyond the upper groove leg in the direction W of principal action of the locking connection or protrudes significantly from it. Thus, the lower groove leg is longer than the upper groove leg, starting from the base of the groove.

Considering the locking groove 15, it is evident that the upper groove leg 16 grasps the thickening 14 by a locking lug 18, which forms a local constriction of the locking groove 15. The lower groove leg serves here as an abutment, counteracting a swinging of the upper region of the bridging component away from the edge trim strip. In the region of the bottom of the groove, the locking groove has a widening adapted to the locking element arranged on the fastening leg in order to accommodate the locking element situated on the fastening leg, especially a thickening or bend arranged on the fastening leg.

It has been found that this configuration makes it possible to produce the edge trim strip without the middle web 7 still required in FIG. 1a and FIG. 1b and nevertheless securely lock the bridging component 2 to the edge trim strip 1. The fastening leg 13 in the region of the trimmed end section E of the edge trim strip 1 forms here the sole section of the cross section profile of the edge trim strip serving for the fastening of the bridging component 2. The fixation of the bridging component 2 to the edge trim strip 1 occurs only on the one fastening leg 13. Thus, the bridging component is held solely by the locking connection formed from the locking groove 15 and the fastening leg 13 on the edge trim strip 1.

FIG. 3a, FIG. 3b and FIG. 3c illustrate in graphic manner through different perspective views the configuration of the bridging component 2 and edge trim strip 1 and moreover illustrate the trimming performed in the end section E for the upper edge region of the edge trim strip, by which the upper profiled leg 11 still present in the middle section M is removed in this region.

On the side of the bridging component facing the inside of the edge trim strip there are provided two locking grooves 15. Two protrusions, projecting beyond the surface of the bridging component facing the inside of the edge trim strip, form the upper groove leg 16 of the locking grooves.

The machining region B shown in FIG. 1b need not be machined in the embodiment shown in FIG. 2 and in FIGS. 3a-3c despite the providing of an end surface A of the edge trim strip produced by overturning of a material region 12.

The bridging component is preferably an injection moulded part made of plastic. The edge trim strip is preferably an extruded metal profile, especially one made of aluminum.

### LIST OF REFERENCE SYMBOLS

1 Edge trim strip
2 Bridging component
3 Base leg
4 Lower visible edge
5 Decorative surface
6 Auxiliary leg
7 Middle web
8 Locking protrusion
9 Locking lug
10 Bearing
11 Upper profiled leg
12 Overturned material region
13 Fastening leg
14 Thickening
15 Locking groove
16 Upper groove leg
17 Lower groove leg
18 Locking lug
E End section
M Middle section
A End surface
B Machining region
W Direction of principal action

What is claimed is:

1. An edge trim strip for mounting on the edge of a vehicle door of a passenger car,
wherein the edge trim strip is trimmed in an end section, where a structural transition to an adjoining strip part is realized when the edge trim strip is arranged per design on the motor vehicle, in order to approximate the contour of the adjacent strip part, the edge trim strip comprises in the end section a cross section profile with a base leg, which forms an outer decorative surface when the edge trim strip is arranged per design on the vehicle, an inwardly facing fastening leg is provided, emerging from the base leg, when the edge trim strip is arranged per design on the motor vehicle, for the fixation of a bridging component on the edge trim strip, wherein the fastening leg is the sole section of the cross section profile of the edge trim strip serving to secure the bridging component.

2. The edge trim strip according to claim 1, wherein there is no middle web extending inwardly from the base leg.

3. The edge trim strip according to claim 2, wherein the fastening leg extends inwardly starting from a lower visible edge of the edge trim strip.

4. The edge trim strip according to claim 3, wherein the fastening leg subtends with the base leg an angle α less than 90°, preferably an angle α less than 45°, more preferably an angle α less than 30°.

5. The edge trim strip according to claim 4, wherein in the region of its end facing away from the base leg the fastening leg forms an undercut, in order to produce a locking element acting transversely to the lengthwise direction of extension of the edge trim strip and able to be grasped by the bridging component.

6. The edge trim strip according to claim 5, wherein the undercut is formed by a thickening, a bend, a depression or a locking lug.

7. The edge trim strip according to claim 6, wherein the edge trim strip has a middle section and a trimmed end section at one end or at both ends, wherein the edge trim strip has in the middle section a C-shaped cross section profile with an upper profiled leg bent inwardly from an upper visible edge and the upper profiled leg is eliminated in the region of the end section as a result of its trimming.

8. The edge trim strip according to claim 7, wherein a material region of the edge trim strip is turned over at the end of the edge trim strip in order to create an end surface.

9. A bridging piece for the bridging, especially in optical manner, of an edge trim strip on a motor vehicle and a structural transition forming a strip component adjacent to the edge trim strip it, wherein the bridging component has a cross section with at least one locking portion which is designed to engage with an undercut located on a fastening leg of the edge trim strip when the bridging component is arranged on the edge trim strip, wherein the locking portion moans is formed by a locking groove, which engages at top and bottom with the fastening leg provided with the undercut in a locking manner.

10. The bridging piece according to claim 9, wherein the locking groove has a widened portion in order to accommodate a locking element located on the fastening leg.

11. The bridging piece according to claim 10, wherein the locking groove has an upper groove leg and a lower groove leg and at least one of the two groove legs has a constriction engaging with the undercut of the fastening leg.

12. The bridging piece according to claim 11, wherein the locking groove has an upper groove leg and a lower groove leg and at least one of the two groove legs forms an abutment for the other groove leg engaging with the undercut of the fastening leg.

13. The bridging piece according to claim 12, wherein one groove leg extends beyond the other groove leg in length, looking in a direction W of principal action of the interlocking.

14. The bridging piece according to claim 13, wherein the bridging component is configured so that it is set on the edge trim strip transversely to its lengthwise extension.

15. A system made from an edge trim strip for mounting on the edge of a vehicle door of a passenger car, and a bridging piece for the bridging, especially in optical manner, of an edge trim strip on a motor vehicle and a structural transition forming a strip component adjacent to the edge trim strip, wherein the fixation of the bridging component on the edge trim strip is done only at the fastening leg.

16. The system according to claim 15, wherein the direction W of principal action of the interlocking between bridging component and edge trim strip is oriented in the yz direction in relation to the vehicle and when the edge trim strip is arranged as designed on the vehicle.

17. (canceled)
